(19) United States
(12) Patent Application Publication
(10) Pub. No.: US 2022/0061008 A1
(43) Pub. Date: Feb. 24, 2022

(54) UART TRANSMISSIONS WITH TWO START BITS FOR AUTOMATIC BAUD DETECTION AND REDUCED CLOCK SKEW

(71) Applicant: Advanced Energy Industries, Inc., Fort Collins, CO (US)

(72) Inventor: Phelim Seamus Bradley, Carrigaline (IE)

(21) Appl. No.: 16/999,894

(22) Filed: Aug. 21, 2020

(51) Int. Cl. H04W 56/00; H04W 72/04; H04W 52/02; G06F 13/42

(52) U.S. Cl. CPC H04W 56/0015; G06F 13/4291; H04W 52/0229; H04W 72/0446

(57) ABSTRACT

This disclosure describes systems, methods, and apparatus for automatically determining an asynchronous serial data transmission rate at the hardware level of UART devices. The UARTs may transmit a bit sequence comprising two start bits to ensure that the receiving device can accurately measure a period of a first start bit and use this period to set a sampling rate of the data bits.

### FIELD OF THE DISCLOSURE

The present disclosure relates generally to UART devices. In particular, but not by way of limitation, the present disclosure relates to systems, methods and apparatuses for automated baud detection to reduce clock skew between transmitting and receiving UART devices.

### DESCRIPTION OF RELATED ART

Asynchronous serial data communication is a common method for sending data between electronic devices. Examples of devices employing asynchronous serial data communications include computers, Global Positioning System (“GPS”) navigation units, and telecommunications radio receivers. Although the transmitter and receiver have no direct means of synchronizing clock signals, they instead rely on operating on similar clock speeds and reset accumulated error at the start of every transmission session.

In a common asynchronous serial data format used to transmit binary data, two data symbol values are used, corresponding to a data line held at one of two levels (“high” and “low”). During idle periods, the data line is held at a specific level, which may be either high or low according to the convention of the system. To indicate the start of a data sequence, a “start bit” is transmitted with the opposite level. A fixed number of data bits follow, usually eight bits from least significant bit (“LSB”, bit 0) to most significant bit (“MSB”, bit 7), with the two data levels (high and low) mapped to the two bit values (one and zero) according to the convention of the system. Following bit 7, a final “stop bit” is sent with a level equal to the idle level.

The level for each bit, including the start and stop bits, is held on the data line for an identical time interval t. Ideally, the receiving device should sample the data line near a center of each data bit, and this shouldn't be an issue since asynchronous serial data is usually transmitted at one of a standard set of data rates, with each bit held for an interval such as 1/2400s, 1/4800s, 1/9600s, etc. For instance, FIG. 7 shows a timing chart of a typical sampling mechanism, where a sampling clock is some multiple of the bit length, and once a start bit is identified, and a middle thereof, sampling of data bits occurs approximately every 16 clock cycles in this example. Before a session begins, the two devices can agree upon this interval or baud rate. However, each device runs its own clock, and thus, despite agreeing upon a baud rate and attempting to sample at a middle of each data bit, the receiving device may not sample at exactly a middle of each data bit. In fact, with sufficient variance in the two clocks, the receiving UART may even miss sampling a data bit and instead sample a subsequent bit as if it was the missed bit, leading to errors. This situation is illustrated in FIG. 1, where the first bit (“0”) is sampled at roughly a middle thereof, but due to a slower clock in the receiving UART, the sampling points gradually slide toward a right edge of the data bits until the “1” in the seventh data bit is missed. The receiving UART thus reads the eighth data bit as the seventh and the stop bit as the eighth data bit. Around 2% variance in the clocks is allowable before this type of error begins to kick in. However, typical oscillators can vary with temperature and from unit to unit, thus making the 2% variance difficult to achieve without expensive stable high precision oscillators (which also take up valuable board space).

To avoid clock misalignment between the transmitting device clock and the receiving device clock one solution is to keep data rates low, but with the ever-increasing volume of data needing to be transferred between modern devices, this solution is rarely acceptable. Other prior art devices use precision timing references, such as crystal oscillators, but these are costly. Other techniques turn to “autobaud” algorithms where a receiving device automatically discriminates among a standard set of data rates. However, they typically look at a trailing edge of a start bit, which can be problematic where the first data bit is the same value as the start bit (i.e., there is no trailing edge of the start bit), or at a later bit. For instance, U.S. Pat. No. 6,198,785 to Flynn (2001), U.S. Pat. No. 7,321,615 to Ryu (2008), and U.S. Pat. No. 6,157,689 to Petty et al (2000) measure an exact duration of a start bit from a leading edge to a trailing edge, but do not account for situations where the start bit and the first data bit have the same value.

Another example, U.S. Pat. No. 6,944,248 to Sullivan (2005) describes a device receiving asynchronous serial communications to match the apparent data rate used by a transmitting device. The apparent duration of a calibration time interval is measured between the leading edge of a start bit and a marker transition at the end of a subsequent data symbol. This timing measurement is then used to calibrate serial communications means, so that subsequent asynchronous serial communications are conducted at the observed data rate.

Other automated baud systems such as U.S. Pat. No. 6,163,586 to Hao (2000) include a transmitting device that sends a specific sequence of characters, a so-called synchronization byte, that the receiver can use to calibrate its clock. LIN networks are one example of this type of automate baud system. For instance, a sequence of bits representing an ASCII character such as “AT” or “U” have been used. As another example, MICROCHIP' s TB3069 includes an autobaud generator that sends an ASCII “U” packet to allow the receiving device to measure baud rate. Yet these techniques use at least a first packet to synchronize the baud rate instead of transmit data, and thus the overall transmission rate is lower. These techniques are especially detrimental when the baud rate is fluctuating or intentionally changed. Many fluctuations in baud rate won't be picked up since the receiving device assumes that the baud rate remains the same once synchronization occurs. However, unless an expensive and precise clock is used in the UART devices, baud rate can fluctuate and the receiving UART may see errors as the sampling rate does not match the transmission rate. Synchronization could occur more often, but will cost the data transfer rate some delay for every synchronization (e.g., 2 to 3 byte transmissions, e.g., 3 ms at 9600 bps). Additionally, typically the receiver will have an application layer modification that allows the receiver to “look” for the synchronization byte at particular times, and this software modification at the application layer, rather than at a hardware layer, is undesirable (e.g., not only does a UART customer buy the hardware, but they also are forced to make a software change). A UART device that can autobaud without modification at the application or software layer is thus desirable.

As seen, known synchronization techniques either use a stable precision timing device, such as a crystal oscillator, or use an autobaud algorithm but then fail to discriminate between non-standard baud rates. Additionally, autobaud algorithms cannot synchronize bytes without a significant loss in effective transmission rate.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as a system for automatically determining an asynchronous serial data transmission rate at a hardware level. The system can comprise a transmission device and at least one receiving device. The transmission device can be coupled to an asynchronous serial link and can have a bit sequence comprising two start bits of opposite polarity, N data bits, and at least one stop bit. The at least one receiving device can be coupled to the asynchronous serial link. The at least one receiving device can be configured to a transmitting device data transmission rate based at least in part on a time between a first leading edge of a first of the two start bits and a second leading edge of a second of the two start bits. The at least one receiving device can be configured to sample at least the N data bits of the bit sequence according to the transmitting device data transmission rate.

Other embodiments of the disclosure may also be characterized as an asynchronous serial data transmission device configured to allow automatic detection of a baud rate at a receiving device's hardware level. The asynchronous serial data transmission device can comprise a baud rate generator and a bit sequence generator. The baud rate generator can be configured to generate the baud rate. The bit sequence generator can be configured to generate bit sequences, at least one of which comprises two start bits of opposite polarity, N data bits, and at least one stop bit. The bit sequence generator can also be configured to generate the bit sequences according to the baud rate, wherein a period between a first leading edge of a first of the two start bits and a second leading edge of a second of the two start bits corresponds to an inverse of the baud rate.

Other embodiments of the disclosure can be characterized as a system for a non-transitory, tangible computer readable storage medium, encoded with processor readable instructions to perform a method for automatically determining an asynchronous serial data transmission rate at a hardware level of a receiving device. The method can comprise receiving, at the receiving device, a bit sequence comprising two start bits of opposite polarity, N data bits, and at least one stop bit, the two start bits being sequential. The method can further comprise identifying, at the receiving device, the asynchronous serial data transmission rate based at least in part on a time between a first leading edge of a first of the two start bits and a second leading edge of a second of the two start bits. The method can yet further comprise sampling the N data bits of the bit sequence according to the asynchronous serial data transmission rate.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 shows a prior art timing diagram with a single start bit;

FIG. 2 shows an example of the present disclosure of a timing chart resulting from the herein-disclosed universal asynchronous receiver-transmitters;

FIG. 3 illustrates an embodiment of a system for automatically determining an asynchronous serial data transmission rate at the hardware level;

FIG. 4 illustrates an embodiment of a system for automatically determining an asynchronous serial data transmission rate at the hardware level;

FIG. 5 illustrates a system utilizing asynchronous serial data communications and the herein disclosed autobaud system with packets having two start bits;

FIG. 6 illustrates a method of automatically determining an asynchronous serial data transmission rate at the hardware level;

FIG. 7 shows a timing chart of a sampling mechanism; and

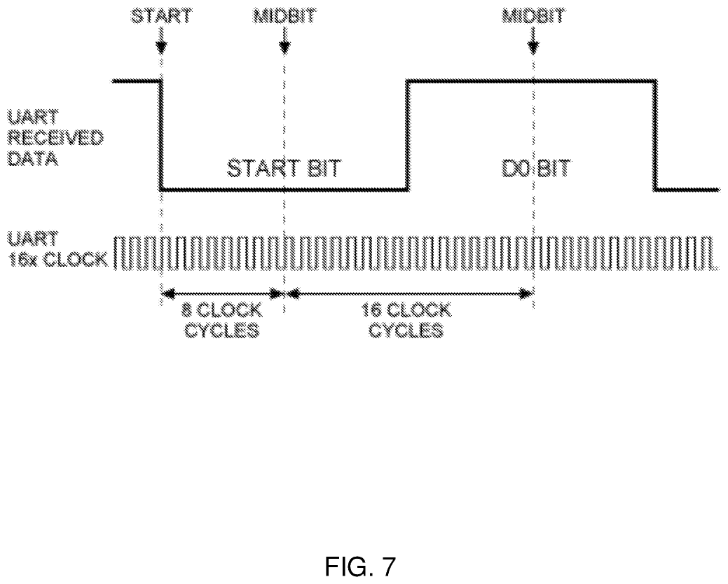

FIG. 8 shows a block diagram depicting physical components that may be utilized to realize the UARTs according to an exemplary embodiment.

### DETAILED DESCRIPTION

This disclosure overcomes the challenges in the art by proposing a UART scheme with two start bits of opposite polarity, thereby ensuring that there is a rising edge following the falling edge of the first start bit.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

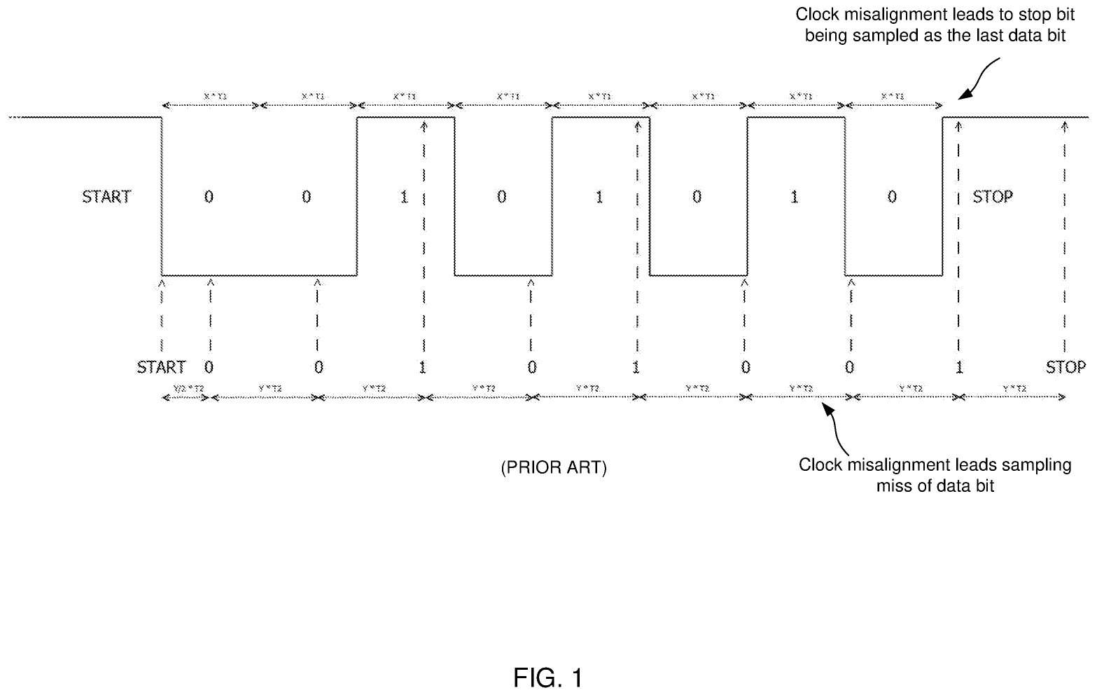

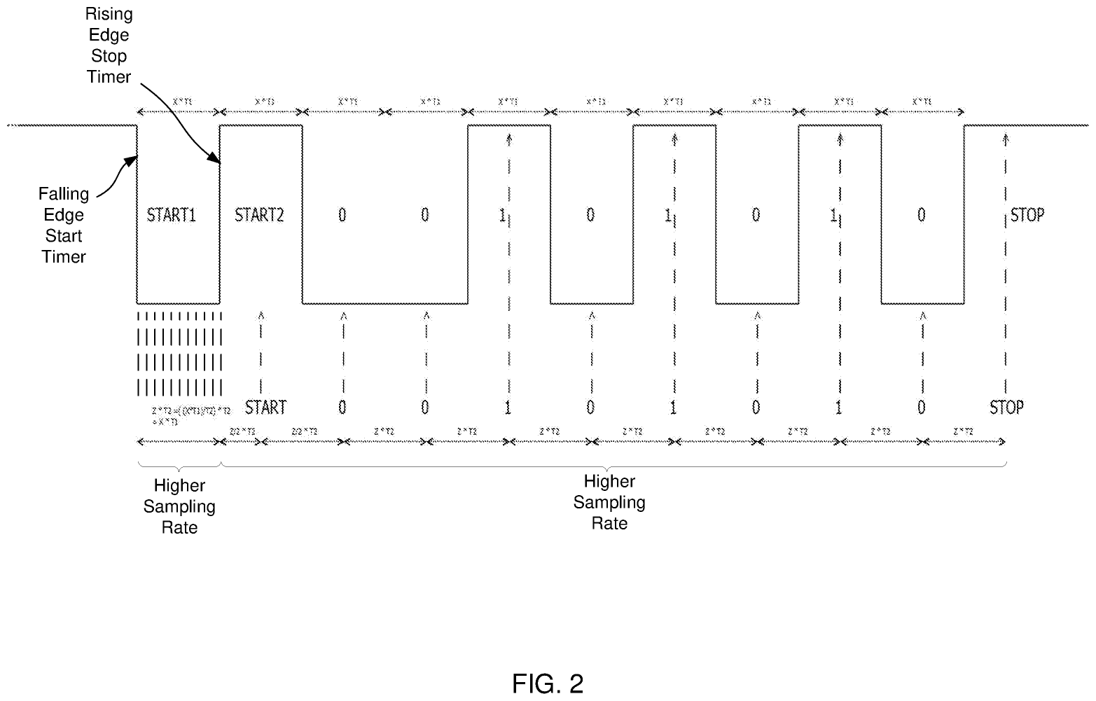

While FIG. 1 shows a prior art timing diagram with a single start bit, FIG. 2 shows a timing chart resulting from the herein-disclosed universal asynchronous receiver-transmitters (UART) system implementing two start bits. In particular, the transmitter starts in the idle state (high or “1”), and then transmits two start bits of opposite polarity. The receiver can identify the falling edge or start of the first start bit, start a timer, identify the rising edge or start of the second start bit (which could also be referred to as a the rising edge or end of the first start bit), and stop the timer to determine a precise and reliable bit length (inverse of the baud rate). The receiver may use its highest sampling rate while trying to measure a length of the first bit as indicated by the plurality of sampling points during the first start bit. In some embodiments this can be referred to as a higher sampling rate than the one used after the baud rate is identified, and need not be a highest sampling rate. The receiver can then sample the subsequent data bits assuming this baud rate (as well as subsequent bit sequences), which guarantees that the receiver samples at a middle of the data bits and negates any variance between the transmitter and receiver clocks. This data bit sampling can be performed at a lower sampling rate such as a rate equivalent to the baud rate, such that one sample per data bit occurs (or a small packet of samples at a multiple of the baud rate (e.g., 16×) can be taken near a middle of each data bit). Thus, synchronization between two UART devices can be achieved without costly precision timing devices, without data transmission rate loss, and without the risk of a single start bit and a first data bit looking identical. Another advantage is that the transmitter's clock can be altered or fluctuate and the receiver can, without errors, track these changes in baud rate.

This solution can also be hardcoded into the UART devices and thus avoid modification of an application layer. Notably, changing configuration of the UART devices to transmit and recognize two start bits will not be noticed at the application layer, which merely transmits bytes to and receives bytes from the hardware layer and is unaware of the intricacies surrounding how the UART devices achieve communication of these bytes. Where a legacy UART receiver is involved, the transmitter can avoid any application layer changes, but the legacy UART receiver may see an application layer modification to allow it to ignore the second start bit since the legacy UART hardware is not configured to handle this extra start bit. This at least allows newer UART devices to maintain compatibility with legacy UART devices with nominal modification to the application layer associated with legacy UARTs.

One downside of the present disclosure is the overhead of an additional bit per bit sequence.

That slight reduction in transmission rate could be overcome by transmitting a greater number of bits per sequence. Traditional systems often limit packets to 8 or 9 data bits since errors are highly likely with longer bit strings. In particular, clock skew accumulates, or increases, with increases in the number of bits per packet. For instance, if the clock skew between UART transmitter and receiver is 5% (i.e., a first data bit is sampled 5% away from a center of that first data bit), then the second bit will be off by 10%, the third will be off by 15%, and so on. This equates to a 40% clock skew at the 8^{th} data bit, which is within acceptability since the offset in the sampling point will not ‘miss’ the 8^{th} bit until the clock skew approaches or exceeds 50%. At greater than 8 bits, this 5% clock skew per bit begins to approach if not exceed the accumulated 50% clock skew threshold that is likely to lead to data bits being missed. For instance, for 16 data bits, the 5% clock skew makes for a roughly 80% accumulated clock skew and nearly guarantees that an error will occur. Hence, traditional systems tend to limit packets to 8 or 9 data bits unless highly-accurate clocks are used in both UART devices. This disclosure avoids errors in sampling, by effectively ignoring the receiver clock, and could thus easily extend bit lengths to 12 or even 16 without increased error rates, thereby increasing the data rate despite the additional start bit.

With the transmitter providing two start bits of opposite polarity, the receiver can operate in one of three different configurations, thereby making this solution backward compatible. In particular, UART receivers can choose to calibrate in real time, occasionally, or not at all. Real time calibration is the most powerful and involves determining a baud for every packet based on the two start bits of every packet. Occasional calibration could be performed by periodically determining a baud and average/filter amongst periodic baud determinations to slowly track the actual transmission baud. Legacy UART hardware, lacking the ability to monitor the first and second start pulses, could use an application layer modification to discard the second of the two start bits from every packet, thereby providing a traditional bit sequence to the application layer.

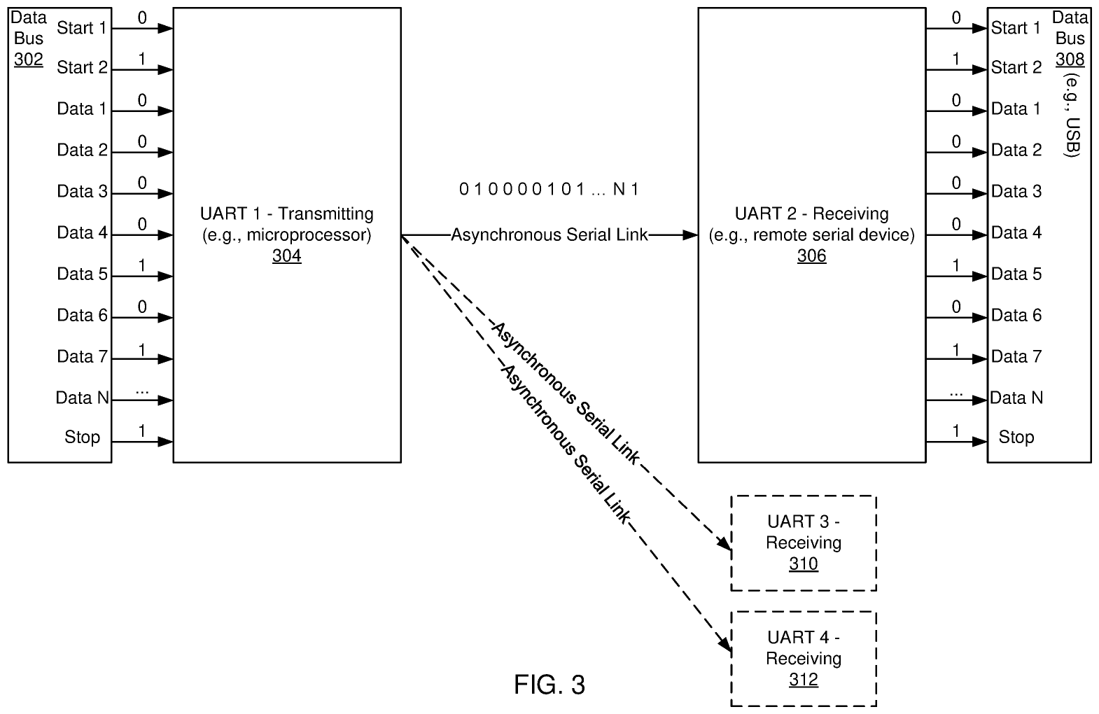

FIG. 3 illustrates an embodiment of a system for automatic detection of an asynchronous serial data transmission rate at the hardware level (or a transmitting device data transmission rate). The system includes two devices (partially shown) in communication via UART devices 304 and 306. The first UART 304 (e.g., a microprocessor) can receive data for transmission over an asynchronous serial link from a data bus 302 of the first device. The data bus 302 can use a parallel communication link with the UART 304. The first UART 304 can convert the parallel data from the data bus 302 to a serial protocol and send a plurality of serial data packets asynchronously over the asynchronous serial link to the second UART 306 (e.g., a remote serial device) and optionally other UART devices 310, 312. The second UART 306 can then convert the serial data to parallel and send this over the second data bus 308 (e.g., a universal serial data bus).

Although UART devices 304 and 306 are configured to operate as transmitter and receiver, in this example, the first UART 304 will be referred to as a transmission device and the second UART 306 will be referred to as a receiving device. The transmitting device 304 can pass through the asynchronous serial link, a bit sequence having two start bits of opposite polarity, along with N data bis (e.g., 8-16 data bits or less than 8 data bits), and at least one stop bit. In an embodiment, the idle signal can be 1 or high, the first start bit can be a 0 or low signal, and the second start bit can be a 1 or high signal. The at least one receiving device 306 can be coupled to the asynchronous serial link and can be configured to identify a transmitting device data transmission rate, or baud, of the transmitting device 304. This can be determined as a time between a leading edge (e.g., falling edge) of the first start bit and a leading edge of the second start bit (e.g., rising edge). This use of two opposite polarity start bits ensures that the first data bit and the end of the start bit don't look the same—this method guarantees that the rising edge of the second start bit will be seen. The receiving device 306 can then sample the N data bits in the sequence according to the identified data transmission rate for the transmitting device. For instance, the receiving device 306 can start sampling one half of a bit period into the second start bit, and take a sample (or small packet of samples) around the middle of subsequent data bits. In some embodiments, the receiving device 306 can determine a baud for every packet, while in other embodiments, the receiving device 306 may determine a baud rate for certain ones of the packets (e.g., less than all packets, every other packet, every third packet, every fifth packet, etc.). The receiving device 306 may then sample based on an average or other combination of determined/identified baud rates (e.g., an average of baud rates for three out of nine of the last nine packets).

While this illustration shows two start bits and a single stop bit, in other embodiments, more than one stop bit can be used.

Although FIG. 3 is shown with a single data direction between UART 304 and UART 306, in other embodiments, this data flow can be reversed (i.e., either UART 304, 306 can be the transmitting or receiving device).

The use of two start bits can be part of the UART hardware configuration and is performed at the hardware level without any modification to the application layer. For instance, traditional UART configurations include writing the byte structure to the configuration register, such as 8N1, 9N1, or 8N2, etc. where the 8 or 9 represents the number of start bits, and the N1 or N2 represents the number of stop bits. To configure a UART to include the herein disclosed two start bits, the following non-limiting examples might be written to the UART configuration register: 2S8N1, 2S16N1 (where 2S represents 2 start bits, 8 and 16 represent a number of data bits, and Ni is the number of stop bits).

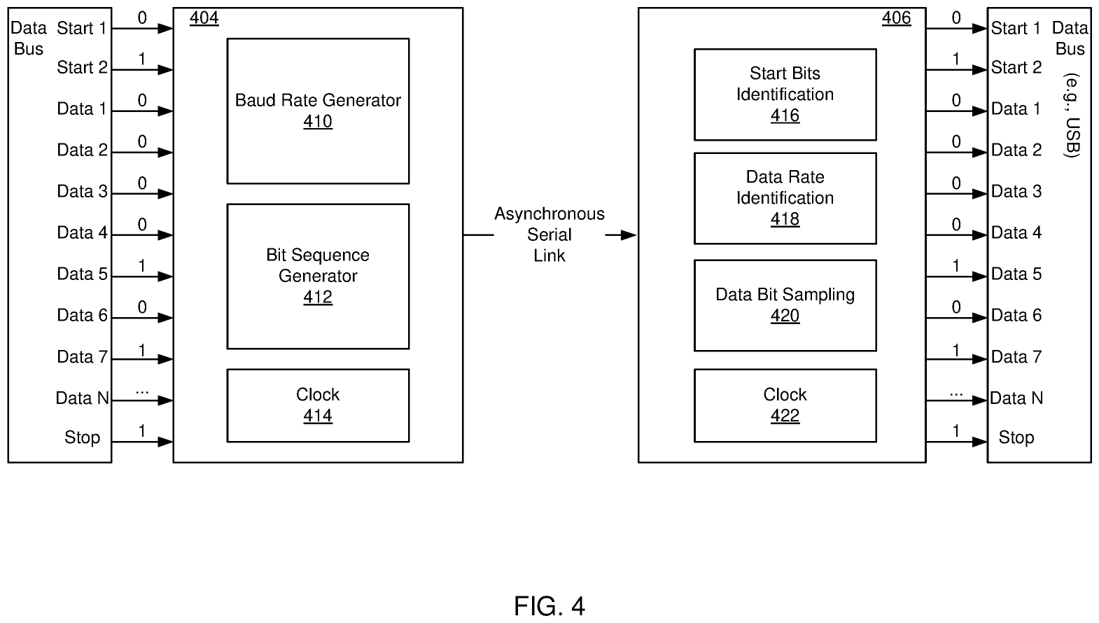

FIG. 4 illustrates an embodiment of a system for automatic detection of an asynchronous serial data transmission rate at the hardware level. The system can include an asynchronous serial data transmission device 404 (the “UART 1”) that is configured to allow automatic baud rate detection at a receiving device's 406 (the “UART 2”) hardware level. UART 1 404 can include a baud rate generator 410, a bit sequence generator 412, and a clock 414. The baud rate generator 410 can be configured to generate a baud rate for the packets sent by the UART 1 404 and this rate can change from packet to packet if the UART 1 404 desires. The baud rate generator 410 can base its baud rate on the clock 414, and thus if the clock 414 and a clock 422 in the UART 2 406 are not perfectly synced or aligned (e.g., in frequency and/or phase), then errors may occur if the UARTs merely synced based on alleged baud rate. This disclosure allows autobaud detection based on the first two start bits, thereby avoiding highly-synchronized clocks 414, 422. The bit sequence generator 412 can be configured to generate bit sequences for transmission through the asynchronous serial link to UART 2 406. At least one of the bit sequences can comprise two start bits of opposite polarity, N data bits, and at least one stop bit (e.g., FIG. 2). The bit sequence generator 412 can also be configured to generate the bit sequence according to the baud rate. For instance, the period between a leading edge of a first of the two start bits and a leading edge of a second of the two start bits corresponds to the inverse of the baud rate.

The receiving device 406 can include a start bits identification 416, a data rate identification 418, a data bit sampling 420, and a clock 422. The receiving device 406 can be configured to identify the asynchronous serial data transmission rate (or baud) as a time between leading edges of the first two start bits. Given this baud rate, which can be determined on a packet-by-packet basis, the receiving device 406 can sample the N data bits in the bit sequence of a corresponding packet according to the baud rate. Alternatively, the baud rate can be determined for less than all packets (e.g., every other packet or every ten packets, to name two non-limiting examples). Where the baud is determined for less than all packets, an average, filter, or some other means of looking at multiple baud samples can be used to determine a baud rate for use during sampling.

The start bits identification 416 can be configured to identify leading edges of the first and second start bits in the bit sequence, and the data rate identification 418 can be configured to determine a baud rate for the transmitting device 404 as a difference in time between the leading edges of the first and second start bits in the bit sequence. With this automatically determined baud rate in hand, the data bit sampling 420 can be configured to sample the N data bits according to an inverse of the transmitting device baud rate (e.g., sampling near a middle of data bits by periodically sampling according to the automatically-determined baud rate).

This embodiment helps to allow UART communication and autobaud detection where the clocks 414 and 422 are more than 2% or more than 5% or more than 10% divergent in frequency and/or phase. Thus, even where an expected baud rate at the receiving UART 2 406 is at least 2%, 5%, or 10% divergent from the actual baud rate, this system allows accurate synchronization between both UARTs 404, 406.

The data rate identification 418 can store its results in a memory or register. This differs from existing systems, which tend to determine and control the determined baud rate at the firmware level rather than at the hardware level.

Although FIG. 4 is shown with a single data direction between UART 304 and UART 306, in other embodiments, this data flow can be reversed (i.e., either UART 304, 306 can be the transmitting or receiving device).

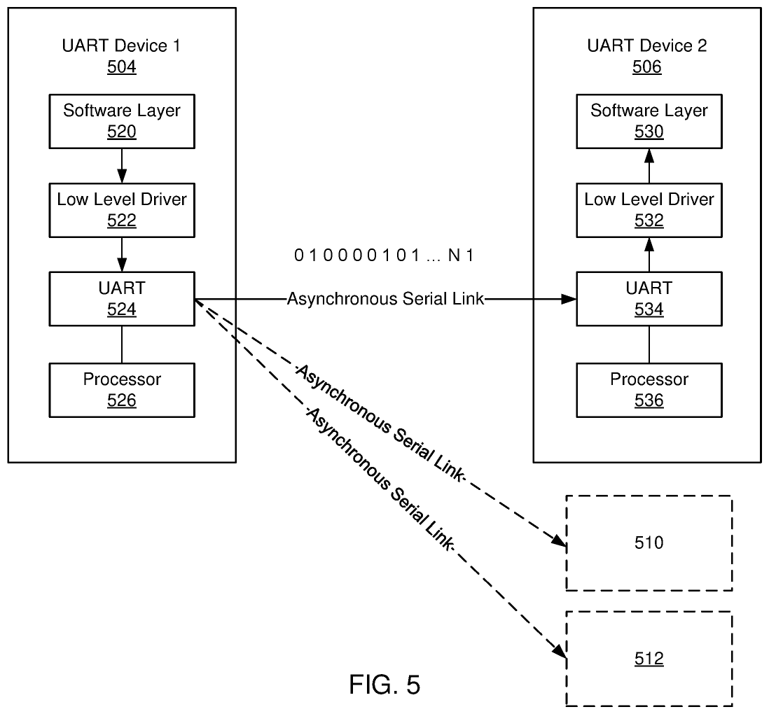

FIG. 5 illustrates a system utilizing asynchronous serial data communications and the herein disclosed autobaud system with packets having two start bits that are sequential. Transmitting UART device 504 can be a device capable of universal asynchronous communications such as a personal computer. Receiving UART device 506 may also be a device capable of universal asynchronous communications such as a modem. Optional receiving UART devices 510 and 512 may also be implemented and have similar structure and function to receiving UART 506.

UART device 504 may include a first upper software layer 520, a first low-level driver 522 and a first UART 524. The first upper software layer 520 may carry out high level functions of UART device 504. For example, first upper software layer 520 may be a software application. First low-level driver 522 may be a low-level software module used to carry out system functions by the first upper software layer 520. The first low level driver 522 may have detailed information regarding the operation of the hardware included in UART device 504, such as the first UART 524. The first UART 524 is a Universal Asynchronous Receiver Transmitter which may carry out asynchronous serial data communications over the asynchronous serial link(s) and is similar to the UARTs 304 and 404. The first UART device 504 may also include a processor 526. The processor 526 may provide internal services to the UART device 504 including synchronization and management of the other components included in UART 504.

The UART 506 may include a second UART 534, a second low level driver 532 and a second upper software layer 530, which may operate in a similar fashion to the analogous components included in UART 504, and a processor 536. The processor 536 may provide internal services to the UART 506 including synchronization and management of the other components included in UART 506. The UART 534 may be similar to the UARTs 306 and 406.

The UARTs 524, 534 may be configured to transmit data packets with two start bits that are sequential, and may be able to receive and autobaud by measuring a period of the first of those two start bits from a leading edge of the first start bit to a leading edge of the second start bit. The receiving UART 506 can store the detected baud rate in a memory or register at the hardware layer and thus the sampling rate can be driven by this rate stored in a register or memory rather than via application code at the software layer 530. Thus, the UART devices 504 and 506 are able to perform auto baud detection at the hardware level rather than at the software layer 520, 530.

Although FIG. 5 is shown with a single data direction between software layer 520 and software layer 530, in other embodiments, this data flow can be reversed (i.e., either UART 524, 534 can be the transmitting or receiving device).

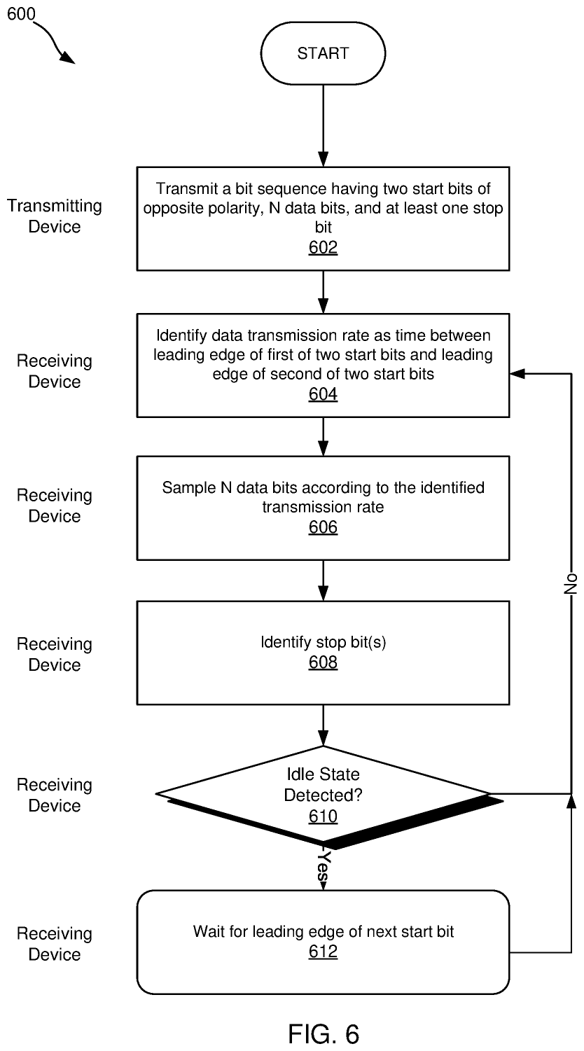

FIG. 6 illustrates a method of automatic detection of an asynchronous serial data transmission rate at the hardware level. The method 600 is performed by a combination of a transmitting device, such as transmitting devices 304, 404, or 504, and a receiving device, such as receiving devices 306, 406, or 506. The transmitting device can transmit a bit sequence having two starting bits of opposite polarity, N data bits, and at least one stop bit (Block 602). Because of the increased synchronization accuracy of the method 600, N can be greater than 9 bits and even up to 16 bits without significant risk or errors being introduced. For instance, the data transmission rate can be between 9/11 and 16/19 (data bits/total bits per packet). While this may not be seen as an increase in the baud rate over traditional systems, it can be seen as an increase in bandwidth. For instance, a 9/11 packet structure sends 9 data bits, two start bits, and one stop bit, or a bandwidth of 9/11 (81.8%), whereas a 16/19 packet structure sends 16 data bits, two start bits, and one stop bit, or a bandwidth of 16/19 (84.2%). The receiving device can then identify an asynchronous serial data transmission rate (e.g., baud rate) as a time between a leading edge of a first of the two start bits and a leading edge of a second of the two start bits (Block 604). The receiving device can then sample the N data bits of the bit sequence according to the asynchronous serial data transmission rate (block 606). A sample or packet of samples (e.g., three samples) can be taken periodically with the period corresponding to an inverse of the asynchronous serial data transmission rate and aimed to occur in a middle of data bits. The identified asynchronous serial data transmission rate can be used to determine a sampling rate for the current packet and optionally subsequent packets (or bit sequences). In some embodiments, a asynchronous serial data transmission rate is determined for less than all packets, and thus some combination of one or more identified asynchronous serial data transmission rates can be used to determine a sampling rate (e.g., an average of the last five identified asynchronous serial data transmission rates). Along these lines, the receiving device can perform identification of the asynchronous serial data transmission rate for substantially half of all bit sequences or packets or most of all bit sequences or packets.

The method 600 can then identify an end of the bit sequence via one or more stop bits (Block 608) and then look for an idle state indicator (Decision 610). Many forms of idle state indicators are available, such as a repeated sequence of high or “1” bits. If the idle state is detected (Decision 610=Yes), then the method 600 can wait for a leading edge of a next start bit (Block 612) and then start determining the baud rate again (Block 604). If the idle state is not detected (Decision 610=No), then the method 300 can return to identify the baud rate of a next bit sequence.

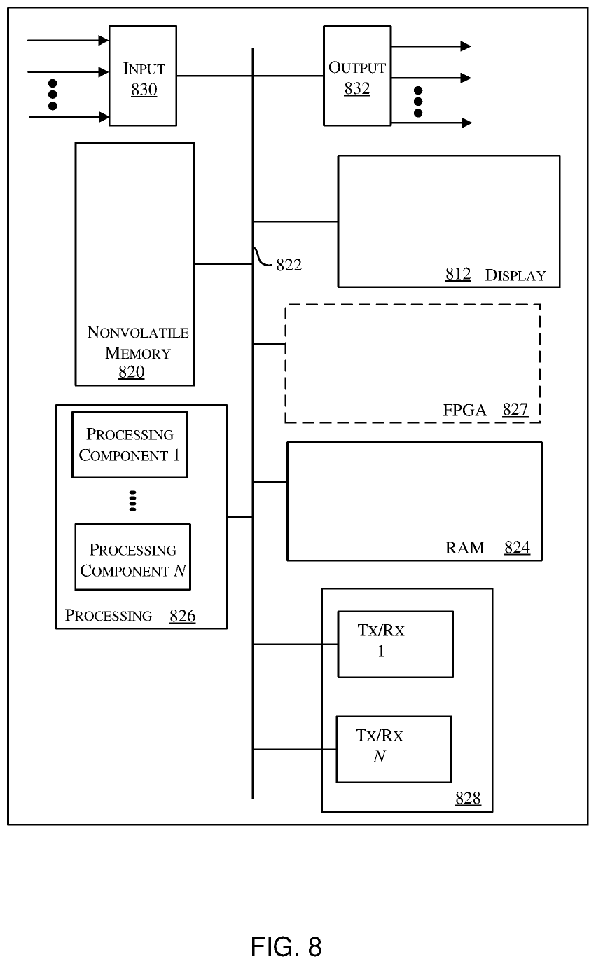

The methods described in connection with the embodiments disclosed herein may be embodied directly in hardware, in processor-readable instructions encoded in a non-transitory tangible processor readable storage medium, or in a combination of the two. Referring to FIG. 8 for example, shown is a block diagram depicting physical components that may be utilized to realize the UARTs 304, 306, 404, 406, 524, and 534 according to an exemplary embodiment. As shown, in this embodiment a display portion 812 and nonvolatile memory 820 are coupled to a bus 822 that is also coupled to random access memory (“RAM”) 824, a processing portion (which includes N processing components) 826, an optional field programmable gate array (FPGA) 827, and a transceiver component 828 that includes N transceivers. Although the components depicted in FIG. 8 represent physical components, FIG. 8 is not intended to be a detailed hardware diagram; thus many of the components depicted in FIG. 8 may be realized by common constructs or distributed among additional physical components. Moreover, it is contemplated that other existing and yet-to-be developed physical components and architectures may be utilized to implement the functional components described with reference to FIG. 8.

This display portion 812 generally operates to provide a user interface for a user, and in several implementations, the display is realized by a touchscreen display. In general, the nonvolatile memory 820 is non-transitory memory that functions to store (e.g., persistently store) data and processor-executable code (including executable code that is associated with effectuating the methods described herein). In some embodiments for example, the nonvolatile memory 820 includes bootloader code, operating system code, file system code, and non-transitory processor-executable code to facilitate the execution of a method described with reference to FIG. 6 described further herein.

In many implementations, the nonvolatile memory 820 is realized by flash memory (e.g., NAND or ONENAND memory), but it is contemplated that other memory types may be utilized as well. Although it may be possible to execute the code from the nonvolatile memory 820, the executable code in the nonvolatile memory is typically loaded into RAM 824 and executed by one or more of the N processing components in the processing portion 826.

The N processing components in connection with RAM 824 generally operate to execute the instructions stored in nonvolatile memory 820 to enable a method for determining an asynchronous serial data transmission rate at the hardware level. For example, non-transitory, processor-executable code to effectuate the methods described with reference to FIG. 6 may be persistently stored in nonvolatile memory 820 and executed by the N processing components in connection with RAM 824. As one of ordinarily skill in the art will appreciate, the processing portion 826 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 826 may be configured to effectuate one or more aspects of the methodologies described herein (e.g., the method described with reference to FIG. 6). For example, non-transitory processor-readable instructions may be stored in the nonvolatile memory 820 or in RAM 824 and when executed on the processing portion 826, cause the processing portion 826 to perform determining an asynchronous serial data transmission rate at the hardware level. Alternatively, non-transitory FPGA-configuration-instructions may be persistently stored in nonvolatile memory 820 and accessed by the processing portion 826 (e.g., during boot up) to configure the hardware-configurable portions of the processing portion 826 to effectuate the functions of the UARTs 304, 306, 404, 406, 524, and 534.

The input component 830 operates to receive signals (e.g., the data bits from the low level driver 522 or data from the data bus 302) that are indicative of one or more aspects of the data bits to be asynchronously transmitted. The signals received at the input component may include, for example, data bits. The output component generally operates to provide one or more analog or digital signals to effectuate an operational aspect of the UARTs 304, 404, 524. For example, the output portion 832 may provide the bit sequence or data packet described with reference to FIG. 2.

The depicted transceiver component 828 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for automatically determining an asynchronous serial data transmission rate at a hardware level, the system comprising:
a transmission device coupled to an asynchronous serial link, a bit sequence comprising two start bits of opposite polarity, N data bits, and at least one stop bit; and
at least one receiving device coupled to the asynchronous serial link and configured to:
identify a transmitting device data transmission rate based at least in part on a time between a first leading edge of a first of the two start bits and a second leading edge of a second of the two start bits; and
sample at least the N data bits of the bit sequence according to the transmitting device data transmission rate.

2. The system of claim 1, wherein the at least one receiving device is configured to sample subsequent bit sequences according to the transmitting device data transmission rate.

3. The system of claim 2, wherein the at least one receiving device is configured to sample the subsequent bit sequences according to a combination of the transmitting device data transmission rate and data transmission rates determined for other bit sequences.

4. The system of claim 3, wherein the at least one receiving device is configured to sample the subsequent bit sequences according to an average of the transmitting device data transmission rate and the data transmission rates determined for other bit sequences.

5. The system of claim 1, wherein the at least one receiving device is configured to identify the transmitting device data transmission rate for most if not all bit sequences.

6. The system of claim 1, wherein the at least one receiving device is configured to identify the transmitting device data transmission rate for substantially half of all bit sequences.

7. The system of claim 1, wherein the transmission device and the at least one receiving device are universal asynchronous receiver-transmitters.

8. An asynchronous serial data transmission device configured to allow automatic detection of a baud rate at a receiving device's hardware level, the asynchronous serial data transmission device comprising:
a baud rate generator configured to generate the baud rate; and
a bit sequence generator configured to generate bit sequences, at least one of which comprises two start bits of opposite polarity, N data bits, and at least one stop bit;
wherein
the bit sequence generator configured to generate the bit sequences according to the baud rate, wherein a period between a first leading edge of a first of the two start bits and a second leading edge of a second of the two start bits corresponds to an inverse of the baud rate.

9. The asynchronous serial data transmission device of claim 8, further comprising a first clock, wherein the first clock is misaligned with a second clock of the receiving device.

10. The asynchronous serial data transmission device of claim 8, wherein an expected baud rate at the receiving device is at least 2% divergent from the baud rate at the asynchronous serial data transmission device.

11. The asynchronous serial data transmission device of claim 10, wherein the expected baud rate at the receiving device is at least 5% divergent from the baud rate at the asynchronous serial data transmission device.

12. The asynchronous serial data transmission device of claim 11, wherein the expected baud rate at the receiving device is at least 10% divergent from the baud rate at the asynchronous serial data transmission device.

13. The asynchronous serial data transmission device of claim 8, wherein N is greater than 8.

14. The asynchronous serial data transmission device of claim 8, wherein the asynchronous serial data transmission device is a universal asynchronous receiver-transmitter.

15. A non-transitory, tangible computer readable storage medium, encoded with processor readable instructions to perform a method for automatically determining an asynchronous serial data transmission rate at a hardware level of a receiving device, the method comprising:
receiving, at the receiving device, a bit sequence comprising two start bits of opposite polarity, N data bits, and at least one stop bit, the two start bits being sequential;
identifying, at the receiving device, the asynchronous serial data transmission rate based at least in part on a time between a first leading edge of a first of the two start bits and a second leading edge of a second of the two start bits; and
sampling the N data bits of the bit sequence according to the asynchronous serial data transmission rate.

16. The non-transitory, tangible computer readable storage medium of claim 15, wherein the receiving device is configured to sample subsequent bit sequences according to a combination of the asynchronous serial data transmission rate and asynchronous serial data transmission rates determined for other bit sequences.

17. The non-transitory, tangible computer readable storage medium of claim 16, wherein the receiving device is configured to sample the subsequent bit sequences according to an average of the asynchronous serial data transmission rate and the asynchronous serial data transmission rates determined for the other bit sequences.

18. The non-transitory, tangible computer readable storage medium of claim 15, wherein the receiving device is configured to identify the asynchronous serial data transmission rate for most if not all bit sequences.

19. The non-transitory, tangible computer readable storage medium of claim 15, wherein the non-transitory, tangible computer readable storage medium is distributed across a transmitting device and the receiving device.

20. The non-transitory, tangible computer readable storage medium of claim 15, wherein a transmitting device and the receiving device are universal asynchronous receiver-transmitters.
